(19) United States
(12) Patent Application Publication
(10) Pub. No.: US 2026/0196539 A1
(43) Pub. Date: Jul. 9, 2026

(54) METHOD FOR DRYING A FUEL CELL SYSTEM

(71) Applicant: Robert Bosch GmbH, Stuttgart (DE)

(72) Inventor: Jochen Braun, Heimsheim (DE)

(21) Appl. No.: 19/132,052

(22) PCT Filed: Nov. 23, 2023
(86) PCT No.: PCT/EP2023/082843

§ 371 Date: May 22, 2025

(30) Foreign Application Priority Data
Dec. 6, 2022 (DE) 10 2022 213 108.8

(51) Int. Cl. H01M 8/04119; H01M 8/04111; H01M 8/04223; H01M 8/04746

(52) U.S. Cl. CPC H01M 8/04179; H01M 8/04111; H01M 8/04253; H01M 8/04776

(57) ABSTRACT

The invention presented here relates to a method (100) for drying a fuel cell system (200). The method (100) comprises:
a cathode path drying step (101) in which:
   shut-off valves (205, 207) at the cathode inlet and cathode outlet of the fuel cell system (100) are opened,
   a cathode path of the fuel cell system (200) is dried by means of a specified air mass flow,
   a turbine bypass path (213) is opened to a specified maximum permissible opening position, wherein the maximum permissible opening position is selected in such a way that it causes a mass flow through a turbine path (219), running parallel to the turbine bypass path (213), towards a turbine (211) of the fuel cell system (200), which mass flow is greater than or equal to a specified minimum turbine threshold value.

### BACKGROUND

The invention presented here relates to a method for drying a fuel cell system and a fuel cell system according to the disclosure.

During the operation of a fuel cell system, oxygen from the ambient air is generally used as an oxidizing agent and fuel or hydrogen is generally used as a reducing agent in order to react to water (or water vapor) in the fuel-cell stack of the system and to therefore supply an electrical power by electrochemical conversion.

The ambient air is supplied to a fuel cell stack by means of an air supply system.

In the case of mobile fuel cell systems, it is very challenging to functionally implement a start-up procedure under all globally relevant conditions and with varying downtimes while achieving maximum reliability.

A problematic start case is the freeze start, i.e. a start-up process at temperatures <0° C., because reaction water produced during the start-up can freeze, and/or thawed water in the system can refreeze in other locations, and/or moisture can condense and freeze during the standstill phase, which leads to ice formation on components of the fuel cell system when, for example, the fuel cell system has not been dried or has not been sufficiently dried during shutdown.

Thus, operating modes preceding of a fuel cell system that are upstream of a start-up process, in particular drying processes, are important in order to ensure a restart.

According to the prior art, the drying of the cathode path is carried out by means of the air compression system with approximately constant operating points.

### SUMMARY

Presented in the context of the invention are a method for drying a fuel cell system and a fuel cell system. Further features and details of the invention arise from the respective description, and the drawings. In this context, features and details described in connection with the method according to the invention clearly also apply in connection with the fuel cell system according to the invention, and vice versa, so that mutual reference to the individual considerations of the invention always is or can be made with respect to the disclosure.

The invention presented here serves in particular to provide a robust fuel cell system.

Therefore, according to a first aspect of the invention presented, a method for drying a fuel cell system is presented.

In this context, an opening position of a path, such as a turbine bypass path, is understood to mean a state of the path in which a cross-section of the path is partially narrowed or obscured, thereby reducing the maximum flow volume of the path accordingly. An opening position can be adjusted, for example, by a valve or slider.

The method presented here comprises a cathode path drying step, in which shut-off valves at the cathode inlet and cathode outlet of the fuel cell system are open, or are opened when they are closed; a cathode path of the fuel cell system is dried by means of a specified air mass flow; and a turbine bypass path of the fuel cell system is opened up to a specified maximum permissible opening position, wherein the maximum permissible opening position is selected in such a way that it causes a mass flow through a turbine path, running parallel to the turbine bypass path, towards a turbine of the fuel cell system, which mass flow is greater than or equal to a specified minimum turbine threshold value.

A minimum turbine threshold value can be, for example, a value or control variable for achieving a minimum enthalpy so as to reach a sufficiently high torque of the turbine, so that the rotational speed of the turbine is adjusted to be greater than or equal to an idling speed. A minimum enthalpy is calculated, for example, from a mass flow rate, a pressure, and a temperature of a respective gas.

The invention presented here is based on the principle that a mass flow of gas(es) conducted via a turbine path to a turbine of a fuel cell system ensures that the turbine rotates continuously and supplies air to the fuel cell system via the compressor powered by the turbine. To achieve this during a drying operation for drying e.g. a cathode path by flowing towards a turbine bypass path, a maximum permissible opening position of the turbine bypass path is provided, so that only a portion of the exhaust mass flow provided by the fuel cell system is conducted through the turbine bypass path, while another, smaller portion of the exhaust mass flow is conducted through the turbine path.

The method presented here is carried out in particular when shutting down and/or at standstill and/or in a phase after driving and/or in standby of a vehicle comprising the fuel cell system, in particular in preparation for a freeze start, in order to protect components of the fuel cell system, in particular its turbine, rotor, adjuster, or sensors in the exhaust path, against damage caused by, for example, droplet impingement, and in particular to ensure functionality for the restart.

By almost completely opening the turbine bypass, i.e. opening the turbine bypass up to the maximum permissible opening position, an output of the turbine and, consequently, a pressure level introduced into the cathode subsystem is minimized. Accordingly, a ratio of mass flow conducted towards the turbine in relation to the provided exhaust mass flow is minimized, or a ratio of mass flow conducted through the turbine bypass in relation to the provided exhaust mass flow is maximized.

Due to the gas bearings of the turbine or a corresponding air supply system, a minimum rotational speed must be maintained for reasons of component protection in order to reliably avoid mechanical friction in the gas bearings, for example. Therefore, a minimum amount of driving torque through the turbine is provided by means of the maximum permissible opening position specified according to the invention. When determining the maximum permissible opening position, factors such as the temperature present in the exhaust path, and thus the heat input into the exhaust path, or the state of heat exchangers can be considered, so that the turbine is supplied with a minimum enthalpy and provides a minimum power output.

By adjusting the turbine bypass up to the maximum permissible opening position, an increase in pressure acting on the turbine is prevented, so that a rotational speed of the turbine can be lower than it would be with a further reduction of the turbine bypass cross-section, which protects the turbine against damage caused by, for example, droplet impingement. Better dehumidification also occurs at lower pressure.

It can be provided that a cathode bypass path is closed during the cathode path drying step.

By closing the cathode bypass path, all gas is conducted into the cathode subsystem, so that the cathode subsystem dries quickly.

It can further be provided that, during the cathode path drying step, a mass flow through a cathode bypass path of the fuel cell system is increased to a specified cathode bypass value while maintaining a constant mass flow in the cathode path by enlarging an opening position of the cathode bypass path and raising a load point of an air supply system of the fuel cell system.

By opening the cathode bypass path during the cathode path drying step, dry air is mixed with the moist air of the cathode exhaust via the cathode bypass, so that the turbine path and the turbine bypass path receive air with lower water content compared to the cathode exhaust.

It can further be provided that the method comprises a bypass drying step, in which the shut-off valves at the cathode inlet and cathode outlet of the fuel cell system are closed, a cathode bypass path of the fuel cell system is at least partially opened, and the maximum permissible opening position of the turbine bypass path is newly determined as a function of an operating point of the fuel cell system, in order to minimize droplet impingement into the turbine and to ensure a specified minimum rotational speed of the turbine.

By simultaneously opening the turbine bypass path and the turbine path, a mass flow conducted through the turbine can be adjusted so that, for example, the turbine is regulated to a specified drying speed, at which the turbine dries but rotates less rapidly than during normal operation, minimizing the risk of damage from droplet impingement.

Furthermore, the turbine bypass path and a bypass path valve located within it are dried through the bypass drying step.

It can further be provided that the method also comprises a turbine drying step in which an opening position of the turbine bypass path is continuously reduced over a specified period of time, so that the rotational speed of the turbine increases.

Through the turbine drying step, a turbine path and the turbine located within it are dried.

Furthermore, it can be provided that a rotational speed of an electric drive of an air supply system of the fuel cell system is continuously decreased over a specified period of time.

By continuously decreasing the opening position of the turbine bypass path, a mass flow conducted through the turbine is continuously increased, resulting in a transient or slow change in the mass flows or flow rates of the gases flowing through the fuel cell system. This leads to a reduction in the risk of damage to the fuel cell system due to droplet impingement compared to a rapid or sudden increase in the mass flows or flow rates.

Decreasing the speed of the electric drive prevents the pressure level in the fuel cell system from increasing due to the faster rotating turbine. The dehumidification or drying is maximized at lower pressures.

In particular, during the turbine drying step, the turbine bypass path is not completely closed, so that a flow continues towards the exhaust path through the turbine bypass path, preventing liquid water from entering the turbine bypass path.

It can further be provided that the bypass drying step and the turbine drying step are performed temporally in parallel or in an alternating manner.

It can further be provided that an adjustment device of the turbine is actuated in order to ensure drying of all turbine surfaces.

An adjustment device of the turbine, such as a VGT, can be operated with a specified trajectory, such as an oscillating movement, in order to move all surfaces of the turbine or respective turbine blades into a mass flow and, consequently, to dry them.

It can further be provided that the method comprises a storage step in which a drying state of the fuel cell system is stored in a memory of the fuel cell system and retrieved upon a restart of the fuel cell system.

A drying state can be, for example, a successfully completed drying process or a cancelled or faulty drying process.

It can further be provided that the fuel cell system comprises a turbine-driven air supply system, and, in case the turbine of the air supply system rotates at a speed that is below a specified minimum rotational speed, or in case it is blocked, the turbine bypass path is closed to at most a specified minimum position, or, in case the turbine of the air supply system rotates at a speed that is greater than or equal to the specified minimum speed, a restriction on the closing of the turbine bypass path by the minimum position is lifted.

To minimize mechanical stress on the turbine in the event of, for example, a turbine blocked by ice formation, the turbine bypass path can be closed up to a specified minimum position, so that a specified minimum bypass flow is set that relieves a pressure from the turbine and accordingly reduces mechanical stress on the turbine.

According to a second aspect, the invention presented here relates to a fuel cell system for converting energy. The fuel cell system comprises a fuel cell stack, wherein the fuel cell stack comprises a cathode subsystem having cathode shut-off valves, an air supply system for supplying air to the cathode subsystem, wherein the air supply system comprises a turbine and a turbine bypass path, and a computing unit, wherein the computing unit is configured so as to carry out a possible implementation of the method presented here.

In the context of the invention presented here, a computing unit is understood to mean a computer, a processor, a control device, or any other programmable circuit.

It can be provided that the fuel cell system comprises a turbine path running parallel to the turbine bypass path.

Furthermore, the fuel cell system can comprise an air supply system in the EAC-TAC, TAC-EAC, and/or EACT configuration.

In the context of the invention presented here, an EAC is to be understood as an electric driven air compressor.

In the context of the invention presented here, a TAC is to be understood as a turbine driven air compressor.

In the context of the invention presented here, an EACT is to be understood as an electric driven air compressor with turbine.

Further advantages, features, and details of the invention arise from the following description, in which exemplary embodiments of the invention are described in detail with reference to the drawings. In this context, the features mentioned in the claims and in the description can each be essential to the invention individually or in any combination.

### BRIEF DESCRIPTION OF THE DRAWINGS

The figures show:

FIG. 1 a possible embodiment of the method presented here,

FIG. 2 a schematic representation of a possible embodiment of the fuel cell system presented here.

### DETAILED DESCRIPTION

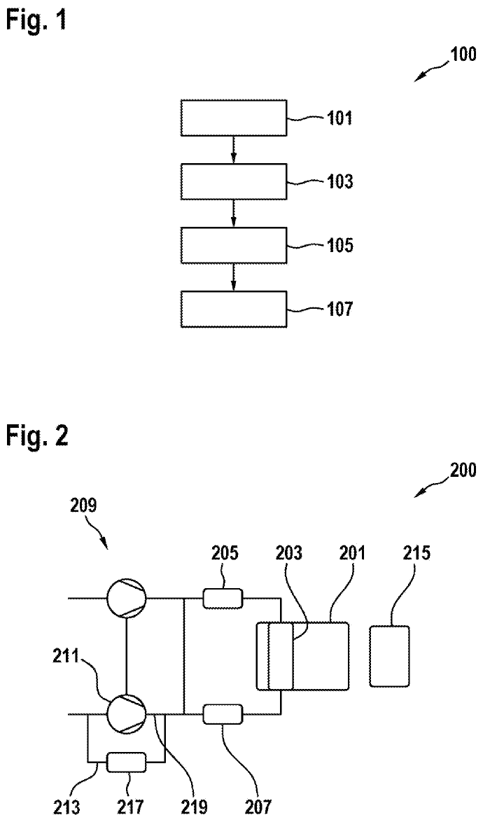

A method 100 for drying a fuel cell system is shown in FIG. 1.

The method 100 comprises a cathode path drying step 101 in which: a) shut-off valves at the cathode inlet and cathode outlet of the fuel cell system are opened,
b) a cathode path of the fuel cell system is dried by means of a specified air mass flow,
c) a turbine bypass path is opened to a specified maximum permissible opening position, wherein the maximum permissible opening position is selected in such a way that it causes a mass flow through a turbine path, running parallel to the turbine bypass path, towards a turbine of the fuel cell system, which mass flow is greater than or equal to a specified minimum turbine threshold value.

Furthermore, the method 100 comprises an optional bypass drying step 03 in which:
the shut-off valves at the cathode inlet and cathode outlet of the fuel cell system are closed,
a cathode bypass path of the fuel cell system is at least partially opened, and
the maximum permissible opening position of the turbine bypass path is newly determined as a function of an operating point of the fuel cell system in order to minimize droplet impingement into the turbine and ensure a specified minimum rotational speed of the turbine.

Furthermore, the method 100 comprises an optional turbine drying step 105 in which:
an opening position of the turbine bypass path is continuously reduced in a specified period of time such that a rotational speed of the turbine increases, and
a rotational speed of an electric drive of an air supply system of the fuel cell system is continuously reduced over a specified period of time.

Furthermore, the method 100 comprises an optional storage step 107, in which a) a drying state of the fuel cell system is stored in a memory of the fuel cell system, and is retrieved upon a restart of the fuel cell system.

FIG. 2 shows a fuel cell system 200. The fuel cell system 200 comprises a fuel cell stack 201, wherein the fuel cell stack comprises a cathode subsystem 203 having cathode shut-off valves 205, 207, an air supply system 209 for supplying air into the cathode subsystem 203, wherein the air supply system 209 comprises a turbine 211 and a turbine bypass path 213 and a computing unit 215 configured so as to carry out the method 100 according to FIG. 1, for example by adjusting a control valve 217 of the turbine bypass path 213 in order to adjust a mass flow through a turbine path 219 for powering the turbine 211.

1. A method (100) for drying a fuel cell system (200), wherein the method (100) comprises:
a cathode path drying step (101) in which:
shut-off valves (205, 207) at a cathode inlet and cathode outlet of the fuel cell system (100) are open or opened,
a cathode path of the fuel cell system (200) is dried by a specified air mass flow,
a turbine bypass path (213) is opened to a specified maximum permissible opening position, wherein the maximum permissible opening position is selected such that it causes a mass flow through a turbine path (219), running parallel to the turbine bypass path (213), towards a turbine (211) of the fuel cell system (200), which mass flow is greater than or equal to a specified minimum turbine threshold value.

2. The method (100) according to claim 1,
wherein
during the cathode path drying step (101), a cathode bypass path is closed.

3. The method (100) according to claim 1,
wherein
during the cathode path drying step (101), a mass flow through a cathode bypass path of the fuel cell system (200) is increased to a specified cathode bypass value while maintaining a constant mass flow in the cathode path by enlarging an opening position of the cathode bypass path and raising a load point of an air supply system (209) of the fuel cell system (200).

4. The method (100) according to claim 1,
wherein
the method (100) further comprises:
a bypass drying step (103) in which
the shut-off valves (205) at the cathode inlet and cathode outlet (207) of the fuel cell system (200) are closed,
a cathode bypass path of the fuel cell system (200) is at least partially opened, and
the maximum permissible opening position of the turbine bypass path (213) is newly determined as a function of an operating point of the fuel cell system (200) in order to minimize droplet impingement into the turbine (211).

5. The method (100) according to claim 1,
wherein
the method (100) further comprises:
a turbine drying step (105) in which an opening position of the turbine bypass path (213) is continuously reduced over a specified period of time.

6. The method (100) according to claim 5,
wherein
the bypass drying step (103) and the turbine drying step (105) are performed temporally in parallel or in an alternating manner.

7. The method (100) according to claim 5,
wherein
in the turbine drying step (105),
a rotational speed of an electric drive of an air supply system (209) of the fuel cell system (200) is continuously reduced over a specified period of time.

8. The method (100) according to claim 1,
wherein
an adjustment device of the turbine (211) is actuated in order to ensure drying of all surfaces of the turbine (211).

9. The method (100) according to claim 1,
wherein
the method (100) further comprises:
a storage step (107) in which a drying state of the fuel cell system (200) is stored in a memory of the fuel cell system (200) and retrieved upon a restart of the fuel cell system (200).

10. The method (100) according to claim 1,
wherein
the fuel cell system (200) comprises a turbine-driven air supply system (209), and, in case the turbine (211) of the air supply system (209) rotates at a speed that is below a specified minimum rotational speed, or in case the turbine (211) is blocked, the turbine bypass path (213) is closed to at most a specified minimum position, or, in case the turbine (211) of the air supply system (209) rotates at a speed that is greater than or equal to the specified minimum speed, a restriction on a closing of the turbine bypass path (213) by the minimum position is lifted.

11. A fuel cell system (200) for converting energy,
wherein the fuel cell system (200) comprises the following:
a fuel cell stack (201),
wherein the fuel cell stack (201) comprises a cathode subsystem (203) having cathode shut-off valves (205, 207),
an air supply system (209) for supplying air into the cathode subsystem (203),
wherein the air supply system (209) comprises a turbine (211) and a turbine bypass path (213),
a computing unit (215),
wherein the computing unit (215) is configured carry out a method (100) according to claim 1.

12. The fuel cell system (200) according to claim 11,
wherein
the fuel cell system (200) comprises a turbine path (219) running parallel to the turbine bypass path (213).

13. The method (100) according to claim 6, wherein in the turbine drying step (105), a rotational speed of an electric drive of an air supply system (209) of the fuel cell system (200) is continuously reduced over a specified period of time.
